(19) United States
(12) Patent Application Publication
(10) Pub. No.: US 2026/0246093 A1
(43) Pub. Date: Aug. 20, 2026

(54) ALKALINE DRY BATTERY

(71) Applicant: Panasonic Intellectual Property Management Co., Ltd., Kadoma-shi, Osaka (JP)

(72) Inventor: Yasuyuki Kusumoto, HYOGO KEN (JP)

(73) Assignee: Panasonic Intellectual Property Management Co., Ltd., Kadoma-shi, Osaka (JP)

(21) Appl. No.: 19/159,800

(22) PCT Filed: Feb. 9, 2024
(86) PCT No.: PCT/JP2024/004448

§ 371 Date: Aug. 26, 2025

(30) Foreign Application Priority Data
Feb. 27, 2023 (JP) 2023-028724

(51) Int. Cl. H01M 50/489; H01M 6/08; H01M 50/107; H01M 50/186; H01M 50/417; H01M 50/469

(52) U.S. Cl. CPC H01M 50/489; H01M 6/085; H01M 50/107; H01M 50/186; H01M 50/417; H01M 50/469

(57) ABSTRACT

An alkaline battery including a battery case having a bottomed cylindrical shape; a negative electrode terminal plate and a gasket; a positive electrode, a negative electrode, a separator, an electrolyte, and a resin sheet that are housed in the battery case. The positive electrode has a cylindrical shape and a first end surface on the negative electrode terminal plate side and a second end surface opposite to the first end surface. The separator includes a cylindrical portion. The resin sheet is annularly disposed along the cylindrical portion on the inner side of the first end surface. The resin sheet has a width W1 from a position facing the first end surface to the negative electrode terminal plate side and a width W2 from the position facing the first end surface to the second end surface side, each not less than 1.0 mm and not more than 3.0 mm.

### TECHNICAL FIELD

The present disclosure relates to an alkaline battery.

### BACKGROUND ART

Alkaline batteries (alkaline manganese batteries) have a larger battery capacity and can deliver a higher current compared to manganese batteries, making them widely used. An alkaline battery includes a positive electrode, a negative electrode, a separator disposed between the positive electrode and the negative electrode, and an alkaline electrolyte. Conventionally, various proposals have been made to enhance the characteristics of alkaline batteries.

Claim 1 of PTL 1 (Japanese Laid-Open Patent Publication No. H7-85855) discloses “a tubular alkaline battery (1) comprising: an annular positive electrode active material (6) disposed inside a positive electrode can (2); and a negative electrode active material (7) made of zinc and filled in a hollow portion of the positive electrode active material via a separator (5), wherein a zinc blocking layer (15) that does not allow zinc crystals to pass through is circumferentially provided at an impurity adhering portion (5a) of the separator”.

Claim 1 of PTL 2 (Japanese Laid-Open Patent Publication No. 2015-170403) discloses “an alkaline battery comprising: a positive electrode member containing manganese dioxide as a positive electrode active material; a negative electrode member containing zinc as a negative electrode active material; a separator disposed between the positive electrode member and the negative electrode member; and an electrolyte containing potassium hydroxide, wherein the separator has a first surface and a second surface, a first layer with low porosity is present on the first surface side, and a second layer with higher porosity than the first layer is present on the second surface side”.

### CITATION LIST

### Patent Literature

PTL 1: Japanese Laid-Open Patent Publication No. H7-85855
PTL 2: Japanese Laid-Open Patent Publication No. 2015-170403

### SUMMARY OF INVENTION

### Technical Problem

In the process of manufacturing an alkaline battery, particles of impurity metals (such as copper, brass, etc.) may enter the battery interior from the opening of the battery case. Particles that enter from the opening are likely to be disposed on the end surface of the positive electrode. If the battery is assembled with impurity metals mixed inside, during the aging process after assembly, the metal particles on the end surface of the positive electrode dissolve, move to the negative electrode side, and precipitate. The growth of precipitated metal may cause micro-short circuits, thereby degrading battery performance (e.g., voltage). In such a situation, one of the objectives of the present disclosure is to provide an alkaline battery that can suppress the degradation of battery performance and has high productivity.

### Solution to Problem

One aspect of the present disclosure relates to an alkaline battery. The alkaline battery includes: a battery case having a bottomed cylindrical shape; a negative electrode terminal plate and a gasket that seal an opening of the battery case; and a positive electrode, a negative electrode, a separator, an electrolyte, and a resin sheet that are housed in the battery case, wherein the positive electrode has a cylindrical shape with a hollow portion at a central portion thereof and has a first end surface on the negative electrode terminal plate side and a second end surface opposite to the first end surface, the negative electrode is disposed in the hollow portion, the separator includes a cylindrical portion disposed between the positive electrode and the negative electrode, the resin sheet is annularly disposed along the cylindrical portion on the inner side of the first end surface, a width W1 of the resin sheet from a position facing the first end surface to the negative electrode terminal plate side is not less than 1.0 mm and not more than 3.0 mm, a width W2 of the resin sheet from the position facing the first end surface to the second end surface side is not less than 1.0 mm and not more than 3.0 mm, and the resin sheet is a non-porous sheet with a water absorption rate of 0.1% or less.

### Advantageous Effects of Invention

According to the present disclosure, an alkaline battery that can suppress the degradation of battery performance and has high productivity can be obtained.

The novel features of the present invention are described in the appended claims, but the present invention, in terms of both structure and content, will be better understood, along with other objectives and features of the present invention, by the following detailed description in conjunction with the drawings.

### BRIEF DESCRIPTION OF DRAWINGS

FIG. 1 is a partially exploded cross-sectional view schematically showing an example of an alkaline battery according to Embodiment 1.

FIG. 2A is an enlarged cross-sectional view of a part of FIG. 1.

FIG. 2B is a developed view schematically showing examples of a resin sheet and a separator used in the alkaline battery according to Embodiment 1.

FIG. 3A is a cross-sectional view schematically showing an example of the arrangement of the resin sheet and the separator.

FIG. 3B is a developed view schematically showing the examples of the resin sheet and the separator shown in FIG. 3A.

### DESCRIPTION OF EMBODIMENTS

Hereinafter, embodiments according to the present disclosure will be described by way of examples, but the present disclosure is not limited to the examples described below. In the following description, specific numerical values or materials may be exemplified, but other numerical values or other materials may be applied as long as the invention according to the present disclosure can be implemented. In this specification, the expression “numerical value A to numerical value B” shall be understood to include both numerical values A and B, and may be interpreted as “not less than numerical value A and not more than numerical value B”. In the following description, when lower and upper limits of numerical values related to specific physical properties or conditions are exemplified, any combination of the exemplified lower limits and upper limits may be adopted, as long as the lower limit does not exceed the upper limit.

### Alkaline Battery

The alkaline battery according to the present embodiment may be referred to as an “alkaline battery (B)” below. The alkaline battery (B) includes: a battery case having a bottomed cylindrical shape; a negative electrode terminal plate and a gasket that seal the opening of the battery case; and a positive electrode, a negative electrode, a separator, an electrolyte, and a resin sheet that are housed in the battery case. The resin sheet may be referred to as a “resin sheet (S)” below. The positive electrode has a cylindrical shape with a hollow portion at a central portion thereof and has a first end surface on the negative electrode terminal plate side and a second end surface opposite to the first end surface. The negative electrode is disposed in the hollow portion of the positive electrode. The separator includes a cylindrical portion disposed between the positive electrode and the negative electrode. The resin sheet (S) is annularly disposed along the cylindrical portion on the inner side of the first end surface (on the central axis side of the battery case). A width W1 of the resin sheet (S) from a position facing the first end surface to the negative electrode terminal plate side is not less than 1.0 mm and not more than 3.0 mm. A width W2 of the resin sheet (S) from the position facing the first end surface to the second end surface side is not less than 1.0 mm and not more than 3.0 mm. The resin sheet (S) is a non-porous sheet with a water absorption rate of 0.1% or less.

PTL 1 discloses an alkaline battery including a zinc blocking layer that does not allow zinc crystals to pass through. However, as a result of investigations, the inventors of the present application newly found that the zinc blocking layer disclosed in PTL 1 cannot sufficiently suppress the degradation of battery characteristics caused by impurity metal particles such as copper. Furthermore, the inventors of the present application newly found that the degradation of battery characteristics caused by impurity metal particles can be particularly suppressed by using the above resin sheet (S). The present disclosure is based on this new finding. As described in the examples, the voltage drop of the battery during aging can be suppressed by using the resin sheet (S). Therefore, the alkaline battery (B) can be manufactured with a good yield.

### Resin Sheet (S)

The resin sheet (S) is described below. Impurity metal particles that enter from the opening of the battery case will be present in the vicinity of the first end surface of the positive electrode. In the absence of the resin sheet (S), the impurity metal dissolves into metal ions and moves to the negative electrode side. The metal ions that reach the negative electrode precipitate on the negative electrode, causing micro-short circuits. On the other hand, by using the resin sheet (S), the movement of impurity metal ions to the negative electrode side can be suppressed.

It is important that the resin sheet (S) is non-porous and has a low water absorption rate. If a nonwoven fabric or a porous membrane is used, metal ions move easily, and the effect cannot be achieved. If a resin sheet with a high water absorption rate is used, the electrolyte permeates the resin sheet, and metal ions pass through the resin sheet and precipitate on the negative electrode. Therefore, a non-porous sheet with a water absorption rate of 0.1% or less is used as the resin sheet (S).

By increasing the widths W1 and W2, the adverse effects of impurity metal particles can be reduced. On the other hand, if the widths W1 and W2 (especially the width W2) are made too large, battery characteristics such as discharge performance tend to degrade. Therefore, the widths W1 and W2 are each set to be not less than 1.0 mm and not more than 3.0 mm.

The width W1 is 1.0 mm or more and may be 1.5 mm or more, 2.0 mm or more, or 2.5 mm or more. The width W1 is 3.0 mm or less and may be 2.5 mm or less, 2.0 mm or less, or 1.5 mm or less. The width W2 is 1.0 mm or more and may be 1.5 mm or more, 2.0 mm or more, or 2.5 mm or more. The width W2 is 3.0 mm or less and may be 2.5 mm or less, 2.0 mm or less, or 1.5 mm or less.

The total width W of the resin sheet (S) is represented by (W1+W2) mm and is specifically not less than 2.0 mm and not more than 6.0 mm. Normally, the widths W, W1, and W2 are constant regardless of the position in the separator. For example, when the planar shape of the separator is rectangular, the width W is constant throughout the separator. However, as long as the widths W1 and W2 are within the above ranges, the widths W, W1, and W2 may vary depending on the position in the separator. In a typical example, the resin sheet (S) is annularly disposed between the positive electrode and the negative electrode so as to extend from a position that is W1 mm away from the first end surface of the positive electrode toward the negative electrode terminal plate, to a position that is W2 mm away from the first end surface toward the second end surface.

The water absorption rate of the resin sheet (S) can be measured by the method specified as Method A in JIS (Japanese Industrial Standard) K 7209:2000. In this method, the water absorption rate is calculated based on the change in mass of the test specimen after immersion in water at approximately 23° C. for approximately 24 hours. A lower water absorption rate indicates lower water absorbency. A resin sheet (S) with a water absorption rate of 0.1% or less can be formed by using a resin material with a water absorption rate of 0.1% or less.

The air resistance (Gurley value) of the resin sheet (S) is preferably greater than 1300 seconds/100 ml. If the air resistance of the resin sheet (S) is greater than 1300 seconds/100 ml, the adverse effects of impurity metal particles can be sufficiently suppressed.

The air resistance is measured by the Gurley test method specified in JIS P 8117:2009. The air resistance can be measured, for example, using a Gurley-type densometer (Toyo Seiki Seisaku-sho, Ltd.). A higher air resistance indicates that gas is less likely to pass through. A sheet with an air resistance greater than 1300 seconds/100 ml can be considered a non-porous sheet that substantially does not allow gas to pass through.

The resin sheet (S) is typically made of resin but may contain a small amount (e.g., 10 mass % or less) of components other than resin (e.g., additives).

The resin sheet (S) may contain a polyolefin resin or may be formed of a polyolefin resin. Polyolefin resins are preferable because they have low water absorption and easily provide a high-quality non-porous film. Examples of polyolefin resins include polymers (homopolymers and copolymers) of olefins (e.g., α-olefins) having 2 to 8 carbon atoms.

The resin sheet (S) may contain at least one selected from the group consisting of polyethylene, polypropylene, and polymethylpentene, or may be made of the at least one selected. These are preferable because they have low water absorption and easily provide a high-quality non-porous film.

The battery case may have an annular groove that protrudes toward the central axis of the battery case and is in contact with the gasket. The groove is formed to seal the opening of the battery case with the negative electrode terminal plate and the gasket. At the groove, the metal plate constituting the battery case is stretched. When the battery case is formed of a plated (e.g., nickel-plated) metal sheet (e.g., steel sheet), the plating layer is stretched and becomes thin at the groove. Therefore, metal ions (e.g., iron ions) are likely to dissolve from the groove portion. Since the alkaline battery (B) includes the resin sheet (S), the adverse effects of metal ions dissolving from the groove can be reduced. This configuration particularly improves reliability when the battery is stored for a long period (e.g., 5 years or more).

The resin sheet (S) has a strip shape and typically has a rectangular planar shape. A rectangular sheet having a width of (W1+W2) mm and a length greater than or equal to the outer circumference of the negative electrode can be used as the resin sheet (S). The number of turns of the resin sheet (S) is one or more, may be two or more, and may be less than three.

The thickness T of the resin sheet (S) is not particularly limited and may be within a range where the above effects can be achieved. By increasing the thickness T, the air resistance can be increased, and the effect of suppressing the permeation of metal ions can be enhanced. The thickness Tis preferably a thickness at which the air resistance of the resin sheet (S) is greater than 1300 seconds/100 ml. By reducing the thickness T, the volume occupied by the resin sheet (S) in the battery can be reduced. The thickness T may be 5 μm or more, 10 μm or more, or 15 μm or more, and may be 50 μm or less, 30 μm or less, 20 μm or less, or 15 μm or less.

The resin sheet (S) can be disposed so as to be in contact with the separator. At least a part of the resin sheet (S) is preferably fixed to the separator. By fixing the resin sheet (S) to the separator, manufacturing becomes easier, and the resin sheet (S) can be easily disposed in an appropriate position. The method of fixing the resin sheet (S) to the separator is not particularly limited and may be welding. Alternatively, the resin sheet (S) and the separator may be bonded using a material for bonding them (e.g., adhesive or resin). The separator to which the resin sheet (S) is fixed may be formed by fixing a long resin sheet (S) to a long separator and then cutting it to a predetermined length.

The resin sheet (S) may be disposed on the side of the inner circumferential surface of the separator or on the side of the outer circumferential surface of the separator. The separator typically includes a cylindrical portion and a bottom portion that closes one end of the cylindrical portion. When the cylindrical portion of the separator is wound two or more turns (e.g., no less than two turns and less than three turns), the resin sheet (S) may be disposed between an inner turn of the separator (e.g., the first turn of the separator) and an outer turn of the separator (e.g., the second turn of the separator). According to this configuration, the resin sheet does not come into contact with the positive electrode or the negative electrode, while the separator comes into contact with the positive electrode and the negative electrode. Therefore, the separator can more easily retain and allow the electrolyte contained in the positive and negative electrodes to pass through. In other words, the separator can more easily function as a pathway for impregnating the positive electrode with the electrolyte during battery assembly, and as both a supply route and a retention layer for water consumed at the positive electrode during discharge.

The alkaline battery (B) according to the present disclosure includes a battery case, a negative electrode terminal plate, a gasket, a positive electrode, a negative electrode, a separator, an electrolyte, and a resin sheet (S), and includes other components as needed. For components other than the resin sheet (S), components used in known alkaline batteries may be used. Examples of components of the alkaline battery (B) other than the resin sheet (S) are described below, but the components of the alkaline battery (B) are not limited to the following examples.

### Positive Electrode

The positive electrode contains manganese dioxide as a positive electrode active material. The positive electrode typically contains a positive electrode active material and a conductive material, and further contains a binder as needed. The positive electrode can be formed by pressure-molding a positive electrode mixture into a cylindrical body (positive electrode pellet). The positive electrode mixture contains, for example, a positive electrode active material, a conductive material, and an alkaline electrolyte, and further contains a binder as needed. After being housed in the battery case, the cylindrical body may be pressurized so as to be in close contact with the wall of the battery case.

As described above, the positive electrode has a cylindrical shape with a hollow portion at a central portion thereof. The positive electrode need only have an overall cylindrical shape and may be constituted of a plurality of cylindrical positive electrode pellets.

A preferable example of manganese dioxide as the positive electrode active material is electrolytic manganese dioxide, but natural manganese dioxide or chemical manganese dioxide may also be used. Examples of the crystal structure of manganese dioxide include α-type, β-type, γ-type, δ-type, ε-type, η-type, λ-type, and ramsdellite-type.

The average particle diameter (D50) of the manganese dioxide powder may be in the range of 25 μm to 60 μm from the viewpoint of ensuring the packing property of the positive electrode and the diffusibility of the electrolyte in the positive electrode. In this specification, the average particle diameter refers to the median diameter (D50) at which the cumulative volume reaches 50% in a volume-based particle size distribution. The median diameter can be determined, for example, using a laser diffraction/scattering particle size distribution analyzer.

From the viewpoint of moldability and suppression of expansion of the positive electrode, the BET specific surface area of manganese dioxide may be, for example, in the range of 20 m²/g to 50 m²/g. The BET specific surface area can be measured, for example, using a specific surface area measuring device by the nitrogen adsorption method.

The conductive material may be a conductive carbon material. Examples of conductive carbon materials include carbon black (e.g., acetylene black), graphite, etc. Examples of graphite include natural graphite, artificial graphite, etc. The conductive material may be in powder form. The average particle diameter (D50) of the conductive material may be in the range of 3 μm to 20 μm. The content of the conductive material in the positive electrode may be in the range of 3 parts by mass to 10 parts by mass (e.g., 5 parts by mass to 9 parts by mass) per 100 parts by mass of manganese dioxide.

To absorb hydrogen generated inside the battery, a silver compound may be added to the positive electrode. Examples of silver compounds include silver oxide (Ag₂O, AgO, Ag₂O₃, etc.), silver nickel composite oxide (AgNiO₂), etc.

### Negative Electrode

The negative electrode contains a zinc alloy powder as a negative electrode active material. From the viewpoint of corrosion resistance, the zinc alloy may contain at least one selected from the group consisting of indium, bismuth, and aluminum. The indium content in the zinc alloy may be, for example, in the range of 0.01 mass % to 0.1 mass %. The bismuth content in the zinc alloy may be, for example, in the range of 0.003 mass % to 0.02 mass %. The aluminum content in the zinc alloy may be, for example, in the range of 0.001 mass % to 0.03 mass %. The content of elements other than zinc in the zinc alloy may be in the range of 0.025 mass % to 0.08 mass % from the viewpoint of corrosion resistance.

The average particle diameter (D50) of the zinc alloy powder may be in the range of 100 μm to 200 μm (e.g., 110 μm to 160 μm) from the viewpoint of the packing property of the negative electrode and the diffusibility of the electrolyte in the negative electrode.

The negative electrode may be a gel-like negative electrode. The gel-like negative electrode can be prepared, for example, by mixing negative electrode active material particles, a gelling agent, and an alkaline electrolyte.

As the gelling agent, any known gelling agent used in the field of alkaline batteries may be used. For example, a water-absorbing polymer may be used as the gelling agent. Examples of gelling agents include polyacrylic acid, sodium polyacrylate, etc. The amount of the gelling agent may be in the range of 0.5 parts by mass to 2.5 parts by mass per 100 parts by mass of the negative electrode active material.

To increase the reaction efficiency on the surface of the negative electrode active material, a surfactant may be added to the negative electrode. Examples of surfactants that may be used include compounds containing polyoxyalkylene groups, phosphate esters, etc. From the viewpoint of more uniformly dispersing additives in the negative electrode, it is preferable to add the additives in advance to the alkaline electrolyte used for preparing the negative electrode.

To improve corrosion resistance, a compound containing a metal with high hydrogen overvoltage, such as indium or bismuth, may be appropriately added to the negative electrode.

### Negative Electrode Current Collector

The alkaline battery (B) may include a negative electrode current collector inserted into the negative electrode. The material of the negative electrode current collector may be a metal (single metal or alloy). The material of the negative electrode current collector preferably contains copper and may be an alloy containing copper and zinc (e.g., brass). The negative electrode current collector may be subjected to a plating treatment, such as tin plating, as needed.

### Separator

A porous sheet having insulating properties can be used as the separator. Examples of the separator include a nonwoven fabric mainly composed of fibers, a microporous resin film, etc. Examples of fiber materials include cellulose, rayon, polyvinyl alcohol, etc. The nonwoven fabric may be formed by blending cellulose fibers and polyvinyl alcohol fibers or by blending rayon fibers and polyvinyl alcohol fibers. Examples of materials for the microporous film include cellophane and resins such as polyolefin. The thickness of the separator may be in the range of 200 μm to 300 μm. The separator may be formed by stacking a plurality of porous sheets. The separator may also be formed by winding a single porous sheet two or more times (e.g., twice).

### Electrolyte

For example, an alkaline aqueous solution containing potassium hydroxide may be used as the electrolyte (alkaline electrolyte). The concentration of potassium hydroxide in the alkaline electrolyte is preferably in the range of 30 to 50 mass % (e.g., in the range of 30 to 40 mass %). The alkaline electrolyte may contain lithium hydroxide (LiOH), sodium hydroxide (NaOH), cesium hydroxide (CsOH), rubidium hydroxide (RbOH), etc.

The alkaline electrolyte may contain a surfactant. By using a surfactant, the dispersibility of the negative electrode active material particles can be enhanced. Examples of surfactants include those exemplified for the negative electrode. The content of the surfactant in the alkaline electrolyte is usually in the range of 0 to 0.5 mass % (e.g., in the range of 0 to 0.2 mass %).

### Battery Housing

The battery housing is constituted of a battery case and a sealing body that seals the opening of the battery case. The sealing body is constituted of a negative electrode terminal plate and a gasket. The battery case has a bottomed cylindrical shape. The negative electrode terminal plate has a substantially disc-like shape. For example, a nickel-plated steel sheet is used for the metal case. To reduce the contact resistance between the positive electrode and the battery case, the inner surface of the battery case may be covered by a carbon film. The negative electrode terminal plate can be formed of the same material as the metal case, for example, a nickel-plated steel sheet. The negative electrode terminal plate functions as a negative electrode terminal. The battery case functions as a positive electrode terminal.

Examples of materials for the gasket include polyamide, polyethylene, polypropylene, polyphenyl ether, polyphenylene ether, etc. From the viewpoint of corrosion resistance to the alkaline electrolyte, preferred materials for the gasket include polyamide-6,6, polyamide-6,10, polyamide-6,12, and polypropylene.

### Method for Manufacturing Alkaline Battery (B)

The method for manufacturing the alkaline battery (B) is not particularly limited. Except for disposing the resin sheet (S), the alkaline battery (B) may be manufactured by any known method. For example, the alkaline battery (B) may be assembled by the procedure described in Examples below.

Hereinafter, examples of embodiments according to the present disclosure will be described in detail with reference to the drawings. The components of the example alkaline battery described below can incorporate the components described above. In addition, the components of the example alkaline battery described below can be modified based on the description above. In addition, the matters described below may also be applied to the above-described embodiments.

### Embodiment 1

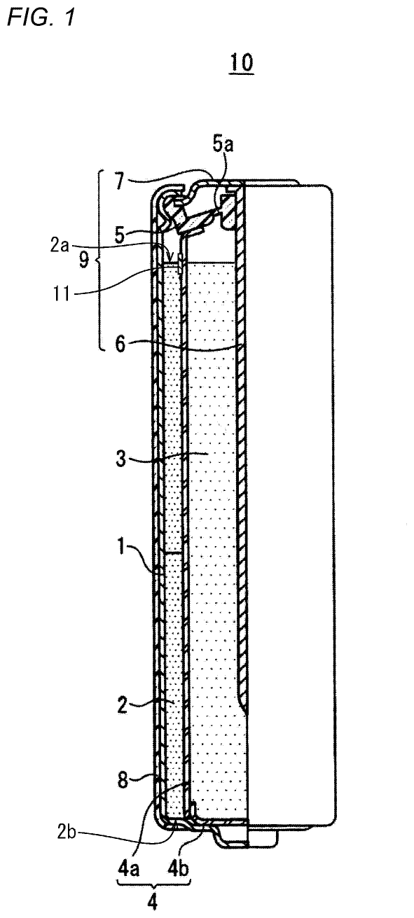

A partially exploded cross-sectional view of an alkaline battery 10 according to Embodiment 1 is shown in FIG. 1. The alkaline battery 10 is a cylindrical battery having an inside-out structure. The alkaline battery 10 includes a battery case 1, and a positive electrode 2, a negative electrode (gel-like negative electrode) 3, a separator 4, a resin sheet 11, and an electrolyte (not shown), which are disposed in the battery case 1.

The battery case 1 is a bottomed cylindrical case and functions as a positive electrode terminal. The positive electrode 2 has a cylindrical shape with a hollow portion at a central portion thereof. The positive electrode 2 is disposed so as to be in contact with the inner wall of the battery case 1. In the example shown in FIG. 1, the positive electrode 2 is formed by stacking two cylindrical positive electrode pellets. The positive electrode 2 has a first end surface 2a on the negative electrode terminal plate 7 side and a second end surface 2b opposite to the first end surface 2a. The negative electrode 3 is disposed in the hollow portion of the positive electrode 2.

The separator 4 is constituted of a cylindrical portion 4a and a bottom portion 4b that closes one end of the cylindrical portion. The cylindrical portion 4a is disposed along the inner surface of the hollow portion of the positive electrode 2, separating the positive electrode 2 and the negative electrode 3. The bottom portion 4b is disposed at the bottom of the hollow portion of the positive electrode 2, separating the negative electrode 3 and the battery case 1.

The opening of the battery case 1 is sealed by a gasket 5 and the negative electrode terminal plate 7 of a sealing unit 9. The sealing unit 9 includes the gasket 5, a negative electrode current collector 6, and the negative electrode terminal plate 7. The negative electrode terminal plate 7 functions as a negative electrode terminal. The negative electrode current collector 6 has a nail shape with a head portion and a body portion. The negative electrode current collector 6 contains, for example, copper and may be made of an alloy containing copper and zinc, such as brass. The negative electrode current collector 6 may be subjected to a plating treatment, such as tin plating, as needed. The body portion of the negative electrode current collector 6 is inserted into a through-hole provided in a central portion of the gasket 5 and into the negative electrode 3. The head portion of the negative electrode current collector 6 is welded to a central flat portion of the negative electrode terminal plate 7.

An annular groove that comes into contact with the gasket 5 is formed in the vicinity of the opening of the battery case 1. The groove protrudes toward the central axis of the battery case 1. The groove is in contact with the gasket 5.

The opening end of the battery case 1 is crimped to the peripheral edge (flange) of the negative electrode terminal plate 7 with the peripheral edge of the gasket 5 interposed therebetween. Most of the outer surface of the battery case 1 is covered by an exterior label 8. The battery case 1, the gasket 5, and the negative electrode terminal plate 7 constitute the battery housing. The positive electrode 2, the negative electrode 3, the separator 4, the resin sheet 11, and the alkaline electrolyte (not shown) are disposed within the battery case 1. Note that the gasket 5 in FIG. 1 includes an annular thin portion 5a.

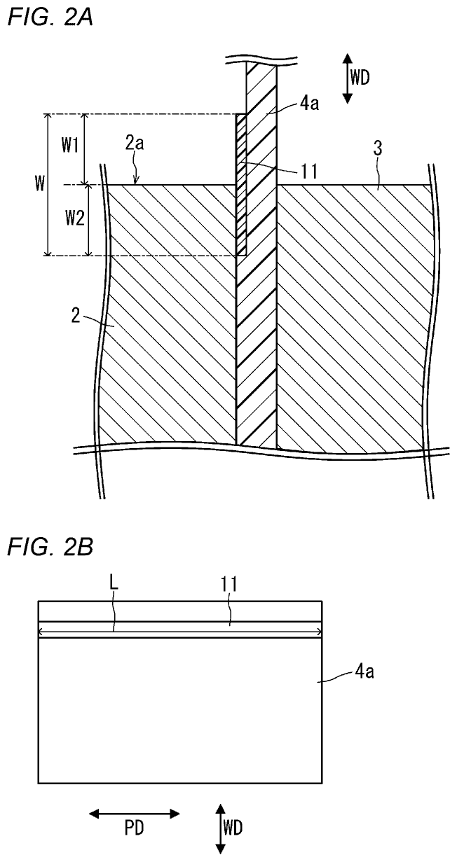

The resin sheet 11 is annularly disposed along the cylindrical portion 4a of the separator 4 located on the inner side of the first end surface 2a of the positive electrode 2. More specifically, the resin sheet 11 is disposed so that a width direction WD (see FIG. 2A) of the resin sheet 11 extends along the central axis of the hollow portion of the positive electrode 2.

A cross-sectional view of the vicinity of the resin sheet 11 is schematically shown in FIG. 2A. In the example shown in FIG. 2A, the resin sheet 11 is disposed on the side of the outer circumferential surface of the separator 4. However, the resin sheet 11 may be disposed on the side of the inner circumferential surface of the separator 4. Alternatively, as described later, the resin sheet 11 may be disposed so as to be sandwiched between two turns of the wound separator 4. The width W1 of the resin sheet 11 from a position facing the first end surface 2a to the negative electrode terminal plate 7 side is within the range described above. The width W2 of the resin sheet 11 from the position facing the first end surface 2a to the second end surface 2b side is within the range described above. In other words, the resin sheet 11 extends from a position that is W1 mm away from the first end surface 2a toward the negative electrode terminal plate 7, to a position that is W2 mm away from the first end surface 2a toward the second end surface 2b.

A developed view of the cylindrical portion 4a of the separator 4 and the resin sheet 11 in FIG. 2A is schematically shown in FIG. 2B. At least a part of the resin sheet 11 is fixed to the cylindrical portion 4a of the separator 4. The planar shape of the resin sheet 11 is a rectangle with a width W of (W1+W2) mm in the width direction WD and a length L slightly longer than the outer circumference of the negative electrode 3 in a circumferential direction PD.

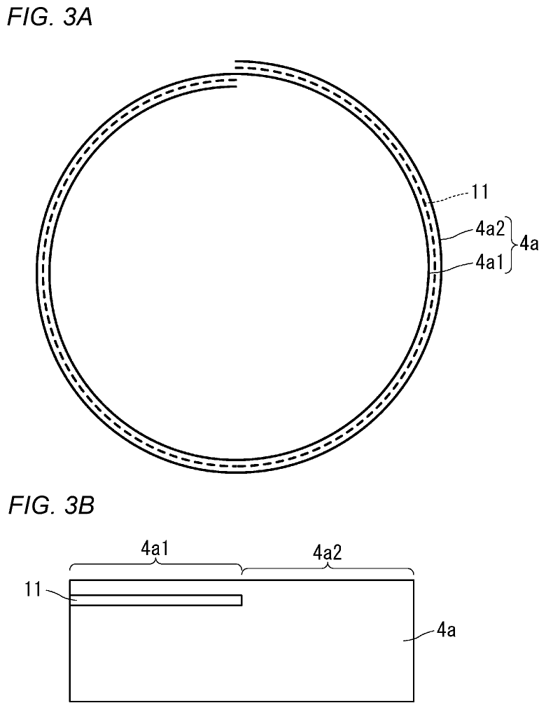

FIG. 3A schematically shows another example of the arrangement of the cylindrical portion 4a of the separator 4 and the resin sheet 11. FIG. 3A is a cross-sectional view in a direction perpendicular to the central axis of the battery case 1. For ease of understanding, in FIG. 3, a first-turn cylindrical portion 4a1, a second-turn cylindrical portion 4a2, and the resin sheet 11 are shown with lines and dotted lines, with gaps between them. In the actual alkaline battery 10, they are in contact with each other.

In the example shown in FIG. 3A, the separator 4 is wound twice. The resin sheet 11 is disposed between the first-turn (inner turn side) cylindrical portion 4al and the second-turn (outer turn side) cylindrical portion 4a2 of the separator 4. A developed view of the separator 4 and the resin sheet 11 shown in FIG. 3A is schematically shown in FIG. 3B. In the example shown in FIG. 3B, the resin sheet 11 is fixed to the outer circumferential surface of the first-turn cylindrical portion 4a1, but the resin sheet 11 may be fixed to the inner circumferential surface of the second-turn cylindrical portion 4a2. Alternatively, the resin sheet 11 may have the same length as the circumferential length of the cylindrical portion 4a wound two or more times. In this case, the resin sheet 11 is wound two or more times in the same manner as the cylindrical portion 4a.

### Supplementary Notes

The following technologies are disclosed by the above description.

### Technology 1

An alkaline battery including:
a battery case having a bottomed cylindrical shape;
a negative electrode terminal plate and a gasket that seal an opening of the battery case; and
a positive electrode, a negative electrode, a separator, an electrolyte, and a resin sheet that are housed in the battery case,
wherein the positive electrode has a cylindrical shape with a hollow portion at a central portion thereof and has a first end surface on the negative electrode terminal plate side and a second end surface opposite to the first end surface,
the negative electrode is disposed in the hollow portion,
the separator includes a cylindrical portion disposed between the positive electrode and the negative electrode,
the resin sheet is annularly disposed along the cylindrical portion on the inner side of the first end surface,
a width W1 of the resin sheet from a position facing the first end surface to the negative electrode terminal plate side is not less than 1.0 mm and not more than 3.0 mm,
a width W2 of the resin sheet from the position facing the first end surface to the second end surface side is not less than 1.0 mm and not more than 3.0 mm, and
the resin sheet is a non-porous sheet with a water absorption rate of 0.1% or less.

### Technology 2

The alkaline battery according to Technology 1, wherein the resin sheet has an air resistance greater than 1300 seconds/100 ml.

### Technology 3

The alkaline battery according to Technology 1 or 2, wherein the resin sheet contains a polyolefin resin.

### Technology 4

The alkaline battery according to any one of Technologies 1 to 3, wherein the resin sheet contains at least one selected from the group consisting of polyethylene, polypropylene, and polymethylpentene.

### Technology 5

The alkaline battery according to any one of Technologies 1 to 4, wherein the battery case has an annular groove in the vicinity of the opening thereof, the groove protruding toward the central axis of the battery case and being in contact with the gasket.

### EXAMPLES

An alkaline battery according to the present disclosure will be described in further detail by way of examples.

### Experiment 1

In Experiment 1, a plurality of alkaline batteries with different resin sheets were prepared and evaluated.

A battery A1 was prepared by the following steps (1) to (5).

### (1) Preparation of Electrolyte (Alkaline Electrolyte)

An alkaline aqueous solution containing potassium hydroxide (concentration: 33 mass %) and zinc oxide (concentration: 2 mass %) was prepared as an alkaline electrolyte.

### (2) Preparation of Positive Electrode

Manganese dioxide (positive electrode active material) and graphite (conductive material) were mixed to obtain a mixture. They were mixed at a mass ratio of 100:6 of manganese dioxide to graphite. Electrolytic manganese dioxide powder (average particle diameter: 40 μm) was used as the manganese dioxide. Graphite powder (average particle diameter (D50): 8 μm) was used as the graphite.

The electrolyte was added to the above mixture and thoroughly stirred, then was compression-molded into flakes to obtain a positive electrode mixture. The mass ratio of the mixture to the electrolyte was set to 100:1.5. The same alkaline electrolyte as that prepared in (1) above was used as the electrolyte.

Next, the flake-shaped positive electrode mixture was pulverized into granules, which were then classified using a 10 to 100 mesh sieve to obtain granules. The obtained granules were pressure-molded into a hollow cylindrical shape (height: 10.8 mm) to obtain a positive electrode pellet. Four such positive electrode pellets were fabricated.

### (3) Preparation of Negative Electrode

A negative electrode active material, an electrolyte, and a gelling agent were mixed to obtain a gel-like negative electrode. The same alkaline electrolyte as that prepared in (1) above was used as the electrolyte. A powdered zinc alloy (average particle diameter: 130 μm) containing 0.02 mass % indium, 0.01 mass % bismuth, and 0.005 mass % aluminum was used as the negative electrode active material. A mixture of crosslinked branched polyacrylic acid and highly crosslinked linear sodium polyacrylate was used as the gelling agent. The mass ratio of the negative electrode active material, the electrolyte, and the gelling agent in the gel-like negative electrode was set to 100:50:1.

(4) Preparation of Separator with Fixed Resin Sheet

A nonwoven fabric sheet formed by blending primarily rayon fibers and polyvinyl alcohol fibers was used as the separator. The mass ratio of the rayon fibers to the polyvinyl alcohol fibers was set to 1:1. Thereafter, as shown in FIG. 3A, a resin sheet (resin sheet (S)) was fixed to a part of the cylindrical portion of the separator on the negative terminal plate side. As shown in FIG. 3A, the cylindrical portion of the separator was wound twice, with the resin sheet disposed between the first and second turns of the separator. A non-porous polyethylene sheet (thickness: 15 μm) was used as the resin sheet. At this time, the width and arrangement of the resin sheet were set so that the values of the width W1 and the width W2 in Table 1 would be satisfied when the battery was assembled. The widths W1 and W2 are the widths W1 and W2 shown in FIG. 2A. The length of the resin sheet (circumferential length L) was set to cover one full turn around the outer circumference of the negative electrode. By joining the bottom portion to the cylindrical portion prepared in this way, the separator with a fixed resin sheet was obtained.

### (5) Assembly of Battery A1

Using the above components, an alkaline battery was assembled by the following method. The procedure for assembling the battery will be described with reference to FIG. 1. First, a coating agent (product name: Bunny Height) manufactured by Nippon Graphite Co., Ltd. was applied to the inner surface of a bottomed cylindrical case made of nickel-plated steel sheet to form a carbon film with a thickness of approximately 10 μm, to obtain the battery case 1. Next, the four positive electrode pellets were vertically inserted into the battery case 1 and thereafter pressure was applied to form the positive electrode 2 that was in close contact with the inner wall of the battery case 1. Next, the separator 4 with the fixed resin sheet 11 prepared in step (4) was disposed inside the positive electrode 2. Next, the alkaline electrolyte prepared in (1) above was injected inside the separator 4 to impregnate the separator 4. In this state, the assembly was left to stand for a predetermined period, allowing the alkaline electrolyte to permeate from the separator 4 into the positive electrode 2. Thereafter, the gel-like negative electrode 3 was filled inside the separator 4.

The negative electrode current collector 6 was formed by subjecting ordinary brass to pressing into a nail shape, and thereafter applying tin plating to the surface thereof. The head portion of the negative electrode current collector 6 was electrically welded to the negative electrode terminal plate 7 made of nickel-plated steel sheet. Thereafter, the body portion of the negative electrode current collector 6 was press-fitted into the through-hole in the center of the gasket 5 mainly composed of polyamide-6,12. In this way, the sealing unit 9 constituted of the gasket 5, the negative electrode current collector 6, and the negative electrode terminal plate 7 was prepared.

Next, the sealing unit 9 was disposed at the opening of the battery case 1. At this time, the body portion of the negative electrode current collector 6 was inserted into the negative electrode 3. Next, the opening end of the battery case 1 was crimped to the peripheral edge of the negative electrode terminal plate 7 with the gasket 5 interposed therebetween, thereby sealing the opening of the battery case 1. In this way, the positive electrode 2, the negative electrode 3, the separator 4, the resin sheet 11, and the alkaline electrolyte were disposed in the battery housing.

Next, the outer surface of the battery case 1 was covered with the exterior label 8. In this way, the battery A1 (alkaline battery) was prepared.

### Batteries A2 to A3, Batteries C1 to C6

Batteries A2 to A3, C1 to C2, and C4 to C6 were prepared by the same method and conditions as the battery A1, except for differences in the material, structure, and thickness of the resin sheet. The size and arrangement of the resin sheet were the same as those of the resin sheet of the battery A1. A battery C3 was prepared by the same method and conditions as the battery A1, except that no resin sheet was used.

### Impurity Metal Particle Mixing Test

The battery A1 was stored at 45° C. for one week after assembly, and the open-circuit voltage (OCV) of the battery was measured after the storage period. Also, copper particles (impurity metal particles) were mixed in during the assembly of the battery A1 by the following method. Specifically, in the assembly of the battery A1, copper particles (particle diameter: 140 μm) were placed on the first end surface of the positive electrode (the end surface on the negative electrode terminal plate side) and pressed from above to be press-fitted into the positive electrode. Thereafter, the battery was assembled. In this way, a battery A1′ with mixed copper particles was prepared. This test simulates a battery with copper particles mixed in during the manufacturing process. The assembled battery A1′ was stored at 45° C. for one week, and the OCV of the battery was measured after the storage period. Thereafter, the decrease in the OCV was calculated using the following equation. A smaller decrease in the OCV indicates that micro short-circuits are more effectively suppressed.

$$OCV decrease = ( OCV of Battery A 1 ) - ( OCV of Battery A {1}^{′} )$$

The batteries A2 to A3 and C1 to C6 were also stored at 45° C. for one week after assembly, and the OCVs of the batteries were measured after the storage period. In addition, batteries A2′ to A3′ and C1′ to C6′ were prepared by mixing copper particles into batteries A2 to A3 and C1 to C6 during assembly, using the same method as described above. These batteries were also stored at 45° C. for one week after assembly, and their OCVs were measured after the storage period. Thereafter, for each battery, the decrease in the OCV was calculated using the same method as described above.

Some of the manufacturing conditions and evaluation results are shown in Table 1. Table 1 shows the water absorption rates of the resins used in the resin sheets of the batteries, as measured by the method described above. Table 1 also shows the thicknesses of the resin sheets used in the batteries. Furthermore, Table 1 shows the values of the widths W1 and W2 described above. Furthermore, Table 1 shows the results of measuring the air resistances of the resin sheets used in the batteries by the method described above. A Gurley-type densometer (Toyo Seiki Seisaku-sho, Ltd.) was used for the measurements. The appropriate measurement range of this device is 1.4 seconds/100 ml to 1300 seconds/100 ml. A resin sheet with a measurement result exceeding 1300 seconds/100 ml (e.g., the resin sheet of the battery A1) indicates that the measurement limit has been exceeded and can be considered a non-porous sheet that does not allow gas to pass through substantially.

TABLE 1

| | | | | Water | | | |
|---|---|---|---|---|---|---|---|
| | | | | absorption | | | |
| | | Width | Width | rate of | | | OCV |
| | | W1 | W2 | resin used | Air resistance | Thickness | decrease |
| Battery | Resin sheet | (mm) | (mm) | (%) | (seconds/100 ml) | (μm) | (mV) |
| A1 | PE non-porous | 2.0 | 2.0 | 0.04 | 1300< | 15 | 0 |
| | sheet | | | | | | |
| A2 | PP non-porous | 2.0 | 2.0 | 0.02 | 1300< | 20 | 0 |
| | sheet | | | | | | |
| A3 | PMP non-porous | 2.0 | 2.0 | 0.01 | 1300< | 20 | 0 |
| | sheet | | | | | | |
| C1 | Cellophane | 2.0 | 2.0 | 4.5 | 1300< | 20 | 24 |
| | non-porous | | | | | | |
| | sheet | | | | | | |
| C2 | PVA non-porous | 2.0 | 2.0 | 30 | 1300< | 50 | 120 |
| | sheet | | | | | | |
| C3 | none | — | — | — | — | — | 140 |
| C4 | PE microporous | 2.0 | 2.0 | 0.04 | 230 | 20 | 120 |
| | sheet | | | | | | |
| C5 | PP microporous | 2.0 | 2.0 | 0.02 | 200 | 20 | 120 |
| | sheet | | | | | | |
| C6 | PMP | 2.0 | 2.0 | 0.01 | 200 | 20 | 120 |
| | microporous | | | | | | |
| | sheet | | | | | | |

PE: Polyethylene,
PP: Polypropylene,
PMP: Polymethylpentene
PVA: Polyvinyl alcohol

The batteries A1 to A3 correspond to the alkaline battery (B) according to the present disclosure. The batteries C1 to C6 are comparative example batteries. As shown in Table 1, the batteries A1 to A3 exhibited no decrease in the OCV even when copper particles were mixed in. On the other hand, the batteries C1 to C6 exhibited a large decrease in the OCV when copper particles were mixed in. In the batteries C1 and C2, it is believed that the high water absorption rates of cellophane and polyvinyl alcohol caused the large decrease in the OCV. In the batteries C4 to C6, it is believed that the use of microporous sheets with low air resistance as resin sheets caused the large decrease in the OCV.

### Experiment 2

In Experiment 2, the batteries A4 to A8 and the batteries C7 to C14 were prepared by the same method and conditions as the battery A1, except that the values of the widths W1 and W2 described above were changed to the values shown in Table 2. The battery A7 has the same configuration as the battery A1.

### Impurity Metal Particle Mixing Test

For each of the prepared batteries, the impurity metal particle mixing test was performed in the same manner as in Experiment 1, and the decrease in the OCV was determined.

### Discharge Performance Evaluation

For the prepared battery A4, a discharge step of discharging for 1 hour with a 3.9Ω resistor connected and a rest step of suspending the discharge for 23 hours, were repeated. Thereafter, the cumulative discharge time until the battery voltage reached 0.8 V was measured. For the other batteries as well, the cumulative discharge time (accumulated value of discharge time) was measured using the same method. A longer cumulative discharge time indicates better discharge performance.

Some of the manufacturing conditions and evaluation results of the batteries are shown in Table 2. In Table 2, the cumulative discharge time is expressed as a relative value with the cumulative discharge time of the battery C7 set to 100.

TABLE 2

| | | Width | Width | Cumulative | |
|---|---|---|---|---|---|
| | | W1 | W2 | discharge time | OCV decrease |
| Battery | Resin sheet | (mm) | (mm) | (Relative value) | (mV) |
| C7 | None | — | — | 100 | 140 |
| C8 | PE non-porous sheet | 0.0 | 0.5 | 100 | 140 |
| C9 | PE non-porous sheet | 2.5 | 0.0 | 100 | 140 |
| C10 | PE non-porous sheet | 0.5 | 0.0 | 100 | 140 |
| C11 | PE non-porous sheet | 0.5 | 0.5 | 100 | 30 |
| A4 | PE non-porous sheet | 1.0 | 2.5 | 100 | 0 |
| A5 | PE non-porous sheet | 1.0 | 1.0 | 100 | 0 |
| A6 | PE non-porous sheet | 1.5 | 1.5 | 100 | 0 |
| A7 | PE non-porous sheet | 2.0 | 2.0 | 100 | 0 |
| A8 | PE non-porous sheet | 2.5 | 3.0 | 100 | 0 |
| C12 | PE non-porous sheet | 2.5 | 4.0 | 95 | 0 |
| C13 | PE non-porous sheet | 2.5 | 5.0 | 90 | 0 |

| | | | | |
|---|---|---|---|---|
| C14 | PE non-porous sheet | (*1) | 95 | 140 |

PE: Polyethylene
(*1) A resin sheet with a width W of 3 mm was placed so as to cover a region extending from the first end surface of the positive electrode to a position 20 to 23 mm toward its second end surface.

The batteries A4 to A8 correspond to the alkaline battery (B) according to the present disclosure. The batteries C7 to C14 are comparative example batteries.

As shown in Table 2, the batteries A4 to A8 exhibited good discharge performance and no decrease in the OCV. It is believed that the large decrease in the OCV in the battery C7 was due to the absence of a resin sheet. It is believed that the large decrease in the OCV in the batteries C8 to C11 was due to the small values of the widths W1 and W2, which provided insufficient suppression of metal ion migration. It is believed that the large decrease in the OCV in the battery C14 was due to the resin sheet not being placed in an appropriate position. It is believed that the short cumulative discharge times of the batteries C12 and C13 were due to the resin sheets having excessive width. It is believed that the short cumulative discharge time of the battery C14 was due to the resin sheet covering the central portion where the discharge reaction between the negative electrode and the positive electrode easily proceeds.

### INDUSTRIAL APPLICABILITY

The present disclosure is applicable to alkaline batteries.

Although the present invention has been described with respect to preferred embodiments at the present time, such disclosure should not be interpreted in a limiting manner. Various modifications and alterations will undoubtedly become apparent to those skilled in the art upon reading the above disclosure. Therefore, the appended claims should be construed to encompass all such modifications and alterations without departing from the true spirit and scope of the present invention.

### REFERENCE SIGNS LIST

1: Battery case, 1a: Groove, 2: Positive electrode, 2a: First end surface, 2b: Second end surface, 3: Negative electrode, 4: Separator, 4a, 4a1, 4a2: Cylindrical portion, 4b: Bottom portion, 5: Gasket, 5a: Thin portion, 7: Negative electrode terminal plate, 10: Alkaline battery, 11: Resin sheet

1. An alkaline battery comprising:
a battery case having a bottomed cylindrical shape;
a negative electrode terminal plate and a gasket that seal an opening of the battery case; and
a positive electrode, a negative electrode, a separator, an electrolyte, and a resin sheet that are housed in the battery case,
wherein the positive electrode has a cylindrical shape with a hollow portion at a central portion thereof and has a first end surface on the negative electrode terminal plate side and a second end surface opposite to the first end surface,
the negative electrode is disposed in the hollow portion,
the separator includes a cylindrical portion disposed between the positive electrode and the negative electrode,
the resin sheet is annularly disposed along the cylindrical portion on the inner side of the first end surface,
a width W1 of the resin sheet from a position facing the first end surface to the negative electrode terminal plate side is not less than 1.0 mm and not more than 3.0 mm,
a width W2 of the resin sheet from the position facing the first end surface to the second end surface side is not less than 1.0 mm and not more than 3.0 mm, and
the resin sheet is a non-porous sheet with a water absorption rate of 0.1% or less.

2. The alkaline battery according to claim 1,
wherein the resin sheet has an air resistance greater than 1300 seconds/100 ml.

3. The alkaline battery according to claim 1,
wherein the resin sheet contains a polyolefin resin.

4. The alkaline battery according to claim 1,
wherein the resin sheet contains at least one selected from the group consisting of polyethylene, polypropylene, and polymethylpentene.

5. The alkaline battery according to claim 1,
wherein the battery case has an annular groove in the vicinity of the opening thereof, the groove protruding toward the central axis of the battery case and being in contact with the gasket.

6. The alkaline battery according to claim 2,
wherein the resin sheet contains a polyolefin resin.

7. The alkaline battery according to claim 2,
wherein the resin sheet contains at least one selected from the group consisting of polyethylene, polypropylene, and polymethylpentene.

8. The alkaline battery according to claim 2,
wherein the battery case has an annular groove in the vicinity of the opening thereof, the groove protruding toward the central axis of the battery case and being in contact with the gasket.
